(19) United States
(12) Patent Application Publication
(10) Pub. No.: US 2024/0208249 A1
(43) Pub. Date: Jun. 27, 2024

(54) DEFORMATION FACTORS BASED ON TENSION AND MEDIA ADVANCEMENT DATA

(71) Applicant: Hewlett-Packard Development Company, L.P., Spring, TX (US)

(72) Inventors: Josep Maria BEL CALAVIA, Sant Cugat del Valles (ES); Andrei Alexandru DAFINOIU, Sant Cugat del Valles (ES); Cristian DIEZ QUILEZ, Sant Cugat del Valles (ES)

(73) Assignee: Hewlett-Packard Development Company, L.P., Spring, TX (US)

(21) Appl. No.: 18/557,645

(22) PCT Filed: Apr. 30, 2021
(86) PCT No.: PCT/US2021/030171

§ 371 Date: Oct. 27, 2023

(51) Int. Cl. B41J 11/00; B41J 11/06; B41J 13/00; B41J 13/03; G06K 15/02

(52) U.S. Cl. CPC B41J 11/008; B41J 11/0095; B41J 11/06; B41J 13/0027; B41J 13/03; G06K 15/1868

(57) ABSTRACT

A printing apparatus is disclosed herein. The apparatus comprises a platen to hold a media thereon, the media moveable along a media path direction; a displacement mechanism to move the media over the platen and along the media path direction; a media advancement sensor to measure the displacement of the media; and a controller. The controller to control the displacement mechanism to move the media over the platen at a tension; to determine, through the media advancement sensor, media advancement data indicative of the displacement of the media; to determine a deformation factor based on the tension and the media advancement data; and to modify a printing parameter based on the deformation factor.

### BACKGROUND

Printers are devices that record images on a printing media. Printers comprise printheads in a carriage that selectively propel an amount of printing fluid on the media. Some printers may include internal printing fluid reservoirs. Other printers may use external printing fluid cartridges as printing fluid reservoirs.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1A is a schematic diagram showing an example of a top view of a printing apparatus with a media thereon;

FIG. 1B is a schematic diagram showing an example of a side view of a printing apparatus with a media thereon;

FIG. 2 is a flowchart of an example method for modifying a printing parameter of a printer;

FIG. 3 is a flowchart of an example method for determining that a media is a rigid media;

FIG. 4 is a flowchart of another example method for modifying a printing parameter of a printer;

FIG. 5A is a flowchart of another example method for modifying a print job image;

FIG. 5B is a flowchart of another example method for applying a correction to a set of areas;

FIG. 5C is a flowchart of another example method for applying a correction to a printhead;

FIG. 5D is a flowchart of another example method for determining a subsequent advancement of a media;

FIG. 6 is a flowchart of another example method for modifying a printing parameter; and

FIG. 7 is a block diagram showing a processor-based system example to modify a printing parameter of a printer.

### DETAILED DESCRIPTION

The following description is directed to various examples of printing systems. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As used herein, the terms “about” and “substantially” are used to provide flexibility to a range endpoint by providing that a given value may be, for example, an additional 15% more or an additional 15% less than the endpoints of the range. In another example, the range endpoint may be an additional 30% more or an additional 30% less than the endpoints of the range. The degree of flexibility of this term can be dictated by the particular variable and would be within the knowledge of those skilled in the art to determine based on experience and the associated description herein.

For simplicity, it is to be understood that in the present disclosure, elements with the same reference numerals in different figures may be structurally the same and may perform the same functionality.

Printing apparatuses, such as printers, comprise a carriage having elements to selectively propel an amount of printing fluid on a media. In some printers, the carriage is a fixed carriage spanning at least the full width of the printable area of the media, such that as the media travels underneath, some elements from the carriage propel the printing fluid and thereby generate the image to be recorded on the media. In other examples, however, the carriage is a scanning carriage which does not span the full width of the printable area of the media. The scanning carriage is therefore controllable to scan across the full width of the printable area of the media (i.e., scanning direction) and to selectively propel the printing fluid on the media. These apparatuses are commonly referred to as scanning printers.

Some printing apparatuses comprise an input roller to host a media roll to be supplied to the printing area. Additionally, some examples further comprise an output roller in which the printed media is rolled. Both input and output rollers may generate a tension to the media such that the media is stretched on the printing area. Other printing apparatuses do not comprise an input roller or/nor the output roller.

Printers additionally comprise a printing platform or platen located under the printing carriage such that the media travels between the platen and the carriage during a printing operation. In some examples, the media may travel at a constant speed (e.g., continuous printing). In other examples, such as in scanning printers, the media may travel in discretional advance segments.

In some of the above examples, some media may behave in an elastic manner and suffer deformations along the media path. In some examples, the deformation may be based on causes external to the type of media, such as the tensions applied by the printing system along the media path (e.g., tensions caused by the output roller, the input roller, the conveyor and the like). As such, the media may not advance in such continuous speed or in the intended discretional advance segments. This may cause quality issues as the printing elements within the printing carriage are accurately controlled to eject printing fluid in specific precise locations. Therefore, accurately controlling the advance of the media, while considering the elastic properties of said media, leads to printed product with a superior print quality.

Some printers may accommodate a plurality of printing media of different thicknesses, stretchability and rigidity values. Some printing media may include paper, textile, vinyl, wood, methacrylate, other plastics, ceramic, foam, metal or composites. Variability in media therefore has an influence on the degree of deformation of such media and how the media travels though the platen.

In the examples herein, the terms “width” and “length” have been used. The two terms are intended to denote two substantially orthogonal directions within a horizontal plane. In further examples, the terms width and length may be used interchangeably. Furthermore, the terms “laterally” and “vertically” have been used. These terms are intended to further denote two substantially orthogonal directions, where laterally is a direction within the horizontal plane and vertically is the orthogonal direction from the horizontal plane (e.g., normal vector). In some examples herein, the “vertical” direction is further referred to media path direction, and the “horizontal” directions is further referred to as scanning direction.

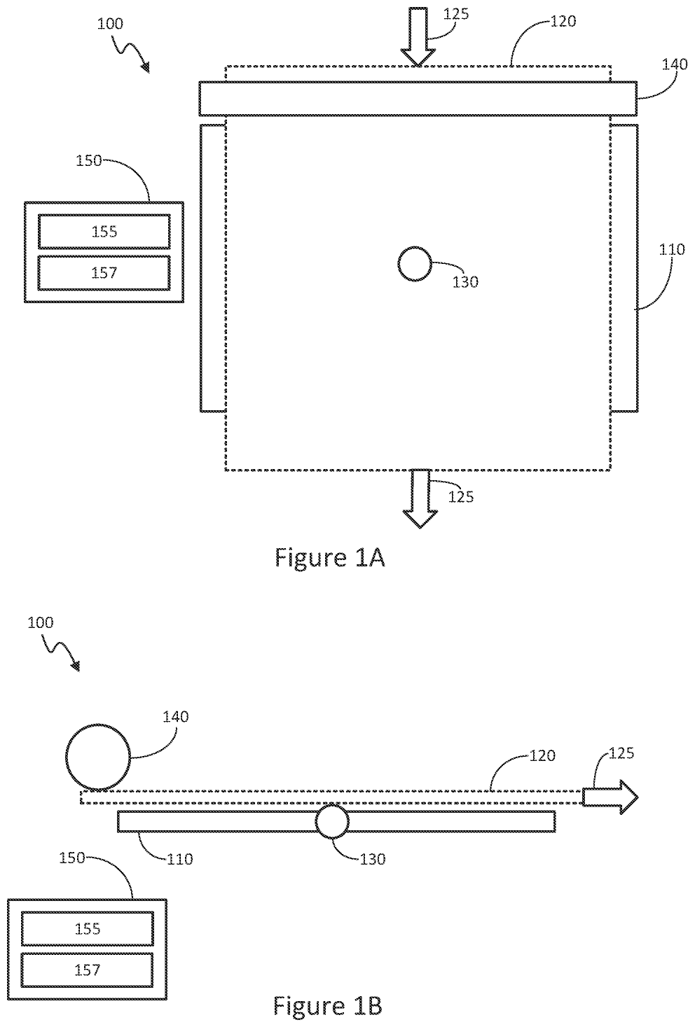

Referring now to the drawings, FIG. 1A-1B are schematic diagrams showing examples of a front and side views of a printing apparatus 100 respectively, such as a printer.

The printing apparatus 100 comprises a platen 110 defining a printing zone. The printing zone is the printable area on the platen 110 which is reachable by a carriage to record an image to a media located thereon. The platen 110 is to hold a media 120 thereon. The media 120 is to move along the length of the platen 110, for example, in a media path direction 125. In the examples herein, the media 120 has been illustrated in dotted lines for clarity purposes, as it is an external element from the apparatus 100 that interacts with the apparatus 100 (e.g., the media may not be present during transportation of the apparatus 100). In some examples, such as the example depicted in FIG. 1A, the width of the media 120 covers substantially the full printable area on the platen 110. In other examples (not shown) however, the width of the media 120 covers a portion of the printable area on the platen 110. In yet other examples, the platen 110 is to hold a plurality of medias 120, the width of the combined plurality of medias 120 covering, at most, substantially the entire printable area on the platen 110.

In some examples, the platen 110 may be a porous platen fluidically connectable to a vacuum source (not shown) such that, when in use, the vacuum source is controlled to cause vacuum conditions to the at least the print area of the platen 110. In some examples, the porous platen may be implemented as a solid platen 110 made out of a porous material with air pockets to enable air to traverse therethrough. In other examples, however, the platen 110 may include a set of perforations or pores of a predefined size or set of predefined sizes distributed across the surface of the platen 110 in fluid communication with the vacuum source. The pores or perforations are to enable a fluid, such as air, to traverse therethrough. The vacuum conditions provide a suction force to the media 120 such that substantially the entire lower surface of the media 120 sticks to the upper surface of the platform 110, thereby substantially inhibiting a vertical movement of the media 110 while enabling a movement of the media along the media path direction.

In some examples, the apparatuses 100A-B comprise a carriage (not shown) including a set of printheads in fluid communication with a set of printing fluids from a supply or cartridge. Some examples of printheads may include thermal inkjet printheads, piezoelectrical printheads, or any other suitable type of printhead. In some examples, the printheads are removable printheads. In other examples, the printheads are an integral part of the carriage. The supply is an external element from the apparatus 100. In some examples, the supply is to be hosted in the carriage, for example in a designated slot within the carriage. In other examples, the supply is to be hosted away from the carriage with fluid pathways that fluidically connect the supply with carriage and/or the printheads within the carriage.

In some examples, the carriage may be controllable to move laterally along a scanning direction (i.e., substantially orthogonal to the media path direction 125) and over the platen 110. In other examples, however, the carriage may not be moveable. When in use, the carriage is further controllable such that the printheads selectively eject amount of a set of printing fluids on the media 120 based on previously received print job data. The print job data may be a digital product including the images and/or text to be recorded on the media. The print job data may be received in a plurality of digital formats, such as JPEG, TIFF, PNG, PDF and the like.

In some examples, the printheads may eject a plurality of printing fluids. A printing fluid may be a solution of pigments dispersed in a liquid carrier such as water or oil. Some recording printing fluids may include Black ink, White ink, Cyan ink, Yellow ink, Magenta ink, Red ink, Green ink, and/or Blue ink. Other non-recording printing fluids may be used to provide additional properties to the printing fluids ejected on the media 120, for example, resistance to light, heat, scratches, and the like.

The apparatus 100 further comprises a displacement mechanism 140. The displacement mechanism 140 may be any mechanism capable of moving the media 120 on the platen 110 along the media path direction 125. The displacement mechanism 140 may be controlled to move the media 120 at an intended tension and speed. In an example, the displacement mechanism 140 is an advancement roller. In some other examples, the displacement mechanism 140 may be the media input roller and/or the media output roller. In yet other examples, the displacement mechanism 140 may be a combination of an advancement roller and at least one of the media input roller and the media output roller. In some examples, the displacement mechanism 140 may span substantially the full width of the platen 110. In other examples, the displacement mechanism 140 comprises a plurality of elements located throughout the width of the platen 110 such that the combined movement of the elements is to controllably move the media 120 along the media path direction 125 at a tension.

The apparatus 110 further includes a media advancement sensor 130. In an example, the media advancement sensor 130 is located along the media path direction 125 downstream the displacement mechanism 140. The media advancement sensor 130 is controllable to measure the displacement (i.e., advance) of the media 120 at the locations in which the media advancement sensor 130 is located thereto. The media advancement sensor 130 may be any sensor suitable for measuring the advance of the media 120, for example by measuring movement, displacement, position, velocity and/or acceleration. Examples of the media advancement sensor 130 may include an optical sensor (e.g., Optical Media Advance Sensor (OMAS), PIXART sensor, camera) or a mechanical sensor (e.g., rotary encoder). The media advancement sensor 130 may be located above or below the moveable media 120. In some examples of mechanical sensors, the sensor may further comprise a rotatory encoder or a shaft encoder to read the displacement of the media 120.

In additional examples, the apparatus 110 may comprise a plurality of media advancement sensors 130 to measure the media 120 advancement at a plurality of respective locations along the media path direction 125. In some examples, a first location may be located at a media input location at the vicinity of the displacement mechanism 140 and a second location may be located at a media output location at substantially the opposite end of the platen 110 with respect to the displacement mechanism 140.

The displacement mechanism 140, the media advancement sensor 130, the movement of the carriage, the printheads, and the movement of the media may be controlled by a set of electronic components, such as a processor, a CPU, a SoC, a FPGA, a PCB and/or a controller. In the examples herein, a controller 150 may be understood as any combination of hardware and programming that may be implemented in a number of different ways. For example, the programming of modules may be processor-executable instructions stored in at least one non-transitory machine-readable storage medium 155 and the hardware for modules may include at least one processor 157 to execute those instructions. In some examples described herein, multiple modules may be collectively implemented by a combination of hardware and programming. In other examples, the functionalities of the controller may be, at least partially, implemented in the form of an electronic circuitry. A controller may be further understood as a distributed controller, a plurality of controllers, and the like.

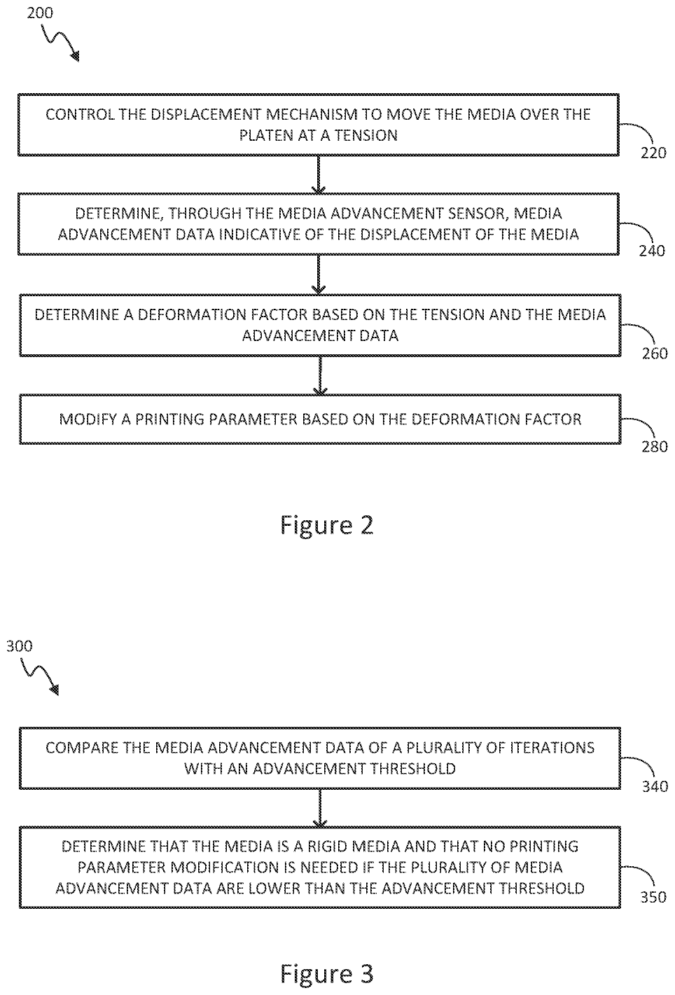

FIG. 2 is a flowchart of an example method 200 for modifying a printing parameter of a printer, for example printer 100. The method 200 may involve previously disclosed elements from FIGS. 1A-B referred to with the same reference numerals. In some examples, parts of the method 200 may be executed by a controller, such as controller 150 from FIGS. 1A-B. In some examples, the method 200 may start by loading a type of media 120 into the printer 100. In other examples, the method 200 may start once the media 120 is already loaded into the printer 100.

At block 220, the controller 150 may control the displacement mechanism 140 to move the media 120 over the platen 110 at a tension. In some examples, the tension is a predetermined tension. The controller 150 may control the tension by controlling the displacement mechanism 140 to function based on an operational parameter. In some examples, the operational parameter may be the angular speed and/or the angular displacement (e.g., displacement mechanism 140 is implemented as a roller). In other examples, the operational parameter may be a rotational speed, position, applied voltage, or any other parameter indicative of the operation of the displacement mechanism 140.

In additional examples, the controller 150 controls the displacement mechanism 140 based on some other parameters. Some examples of these parameters may include the type of media 120, the thickness of the media 120, the width of the media 120, the media input roller radius, the media output roller radius, the voltage of the displacement mechanism 140, and/or the platen 110 vacuum level. Some of these parameters may be controlled by a controller other than the controller 150.

At block 240, the controller 150 may determine, through the media advancement sensor 130, media advancement data indicative of the displacement of the media 120. In some examples, the media advancement sensor 130 may measure the displacement of the media 120 over a predetermined amount of time. In other examples, the media advancement sensor 130 may measure the time in which the media has displaced for a predetermined distance. In yet other examples, the media advancement sensor 130 may measure the displacement of the media 120 using any other measurable metric indicative of the displacement of the media 120.

At block 260, the controller 150 may determine a deformation factor based on the tension applied to the media 120 and the media advancement data.

The deformation factor is thereby indicative of the deformation of the media 120 along the media path direction 125. It is to be noted that, in some examples, the media 120 deformation behaves in a linear elastic deformation manner. As such, when within the elastic range, the deformation of the media 120 is proportional to the tension applied.

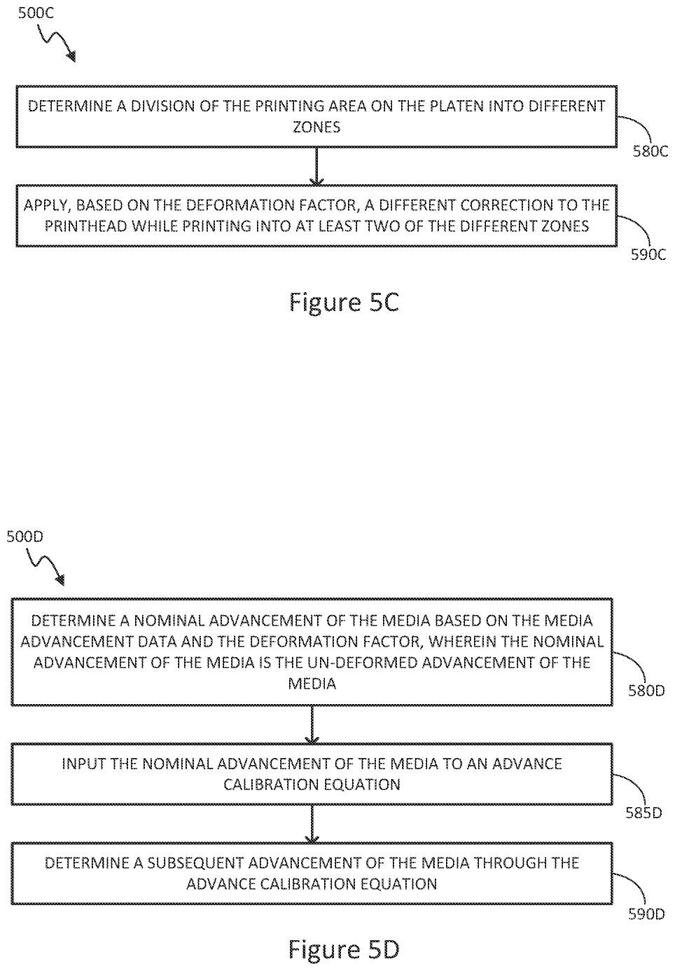

At block 280, the controller 150 may modify a printing parameter based on the deformation factor. In some examples, the modification of the printing parameter is executed after the media loading and before the print job execution. In other examples, the modification of the printing parameter is executed while the print job is being executed. Some examples of printing parameters may include modifying a print job image based on the deformation parameter (e.g., deforming the image by stretching it in the media path direction), applying a correction to an area of a printhead, applying a correction to a printhead based on printing area, the amount of media to move in a subsequent print pass, and the like. Some of these examples are explained below with reference to FIGS. 5A-D.

FIG. 3 is a flowchart of an example method 300 for determining that a media 120 is a rigid media. Method 300 may involve previously disclosed elements from FIGS. 1A-B referred to with the same reference numerals. In some examples, parts of the method 300 may be executed by a controller, such as controller 150 from FIGS. 1A-B. Method 300 may be implemented after the execution of block 240 from FIG. 2.

In the examples herein, method 300 is a method in which the controller 150 is to control the displacement mechanism 130 and to determine the media advancement data in an iterative manner. In some examples, two consecutive iterations may be executed after a predetermined amount of time. For example, each iteration may be completed in less than about 100 ms. In other examples, each iteration may be completed in less than about 10 ms, such as about 2.4 ms. In additional examples, two consecutive iterations may be executed in two consecutive print passes or in two non-consecutive print passes. In yet other additional examples, two consecutive iterations may be executed in two consecutive media advancement passes.

At block 340, the controller 150 is to compare the media advancement data of a plurality of iterations with an advancement threshold. The advancement threshold may be determined based on the nominal advancement of the media 120 in the iteration with an increment of advancement. Such increment of advancement is indicative on the maximum allowable advancement of the media 120 in the iteration caused by the flexibility of a rigid media 120. In the examples herein, a rigid media 120 is a media 120 in which a printing parameter does not need to be modified without experiencing image quality defects.

At block 350, the controller 150 is to determine that the media is a rigid media and that no printing parameter modification is needed. The controller 150 is to make said determination if the plurality of media advancement data are lower than the advancement threshold.

Additionally, in some examples, the controller 150 is to control the displacement mechanism 130 to move the media over the platen 110 at an increasing tension in the different iterations to detect the presence of a rigid media 120 in a more efficient manner.

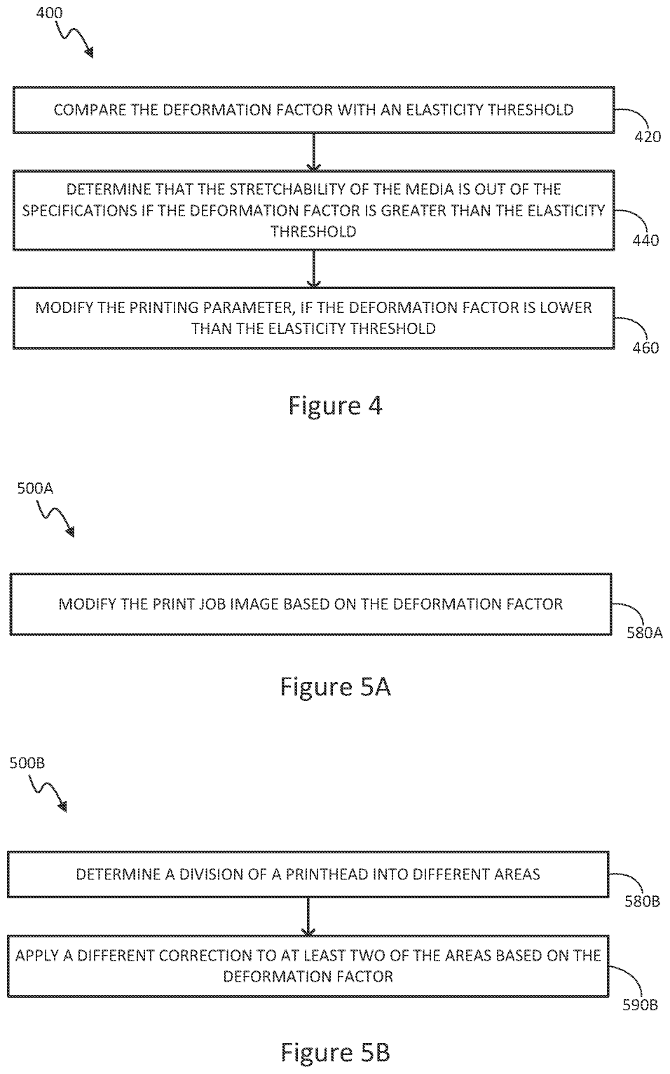

FIG. 4 is a flowchart of another example method 400 for modifying a printing parameter of a printer, for example printer 100. Method 400 may involve previously disclosed elements from FIGS. 1A-B referred to with the same reference numerals. In some examples, parts of the method 400 may be executed by a controller, such as controller 150 from FIGS. 1A-B. Method 400 may be implemented after the execution of block 260 from FIG. 2.

At block 420, the controller 150 may compare the deformation factor with an elasticity threshold. In the examples herein, the elasticity threshold may be indicative to the maximum deformation of a media 120, such that the printed product remains within the printing specifications. In other words, the elasticity threshold is the maximum deformation of the media 120 that can be remedied through a modification of a printing parameter, without compromising the image quality of the printed product.

At block 440, the controller 150 is to determine that the stretchability of the media 120 is out of the specifications if the deformation factor is greater than the elasticity threshold. Then, the controller is to abort the print job. In some examples, the controller 150 is to alert the user through a user interface of the printer or through sound or visual means, such as an alarm.

Likewise, the controller 150 is to determine that the stretchability of the media is within the specifications if the deformation factor is greater than the elasticity threshold. The controller 150 is then to execute block 460 in which the controller 150 is to modify the printing parameter as in block 280 of FIG. 2.

FIGS. 5A-D are flowcharts of example methods 500A-D of modifying a printing parameter. As such, these methods may be implementing examples of block 280 of FIG. 2. These methods 500A-D may involve previously disclosed elements from FIGS. 1A-B referred to with the same reference numerals. In some examples, parts of the methods 500A-D may be executed by a controller, such as controller 150 from FIGS. 1A-B.

FIG. 5A is a flowchart of an example method 500A for modifying a print job image. At method 500A, the printing parameter is a print job image.

At block 580A, the controller 150 is to modify the print job image based on the deformation factor. The printer 100 is then to generate the printed product based on the modified print job image such that the un-stretched media with the modified printed job image corresponds to the non-modified print job image.

FIG. 5B is a flowchart of an example method 500B for applying a correction to a set of areas. At method 500B, the printing parameter is a printhead alignment.

At block 580B, the controller 150 is to determine a division of a printhead into different areas of nozzles. As such each of the defined areas corresponds to a set of nozzles in which a set of printing fluids are to be propelled therethrough.

At block 590B, the controller 150 is to apply a different correction to at least two of the areas based on the deformation factor. In an example, these corrections may be based on a DNX functionality of the printer. The DNX functionality applies a scanning axis correction to each zone based on the media stretchability (i.e., deformation factor).

FIG. 5C is a flowchart of an example method 500C for applying a correction to a printhead. At method 500C, the printing parameter is a printhead alignment.

At block 580C, the controller 150 is to determine a division of the printing area on the platen 110 into different zones.

At block 590C, the controller 150 is to apply, based on the deformation factor, a different correction to the printhead while printing into at least two of the different zones. These corrections may be based on different print modes or any other printhead alignment technique.

FIG. 5D is a flowchart of an example method 500D for determining a subsequent advancement of the media 120. At method 500D, the printing parameter is the advancement of the media 120.

At block 580D, the controller 150 is to determine a nominal advancement of the media 120 based on the media advancement data and the deformation factor. In the examples herein, the nominal advancement of the media 120 is to be understood as the un-deformed advancement of the media 120.

At block 585D, the controller 150 is to input the nominal advancement of the media 120 to an advance calibration equation. The advance calibration equations are the techniques that calculate the displacement amount of the subsequent media displacement along the media path direction 125. Some examples of advance calibration equations are DMS (Dynamic Media Factor) and/or DSA (Drop Shape Analyzer).

At block 590D, the controller 150 is to determine a subsequent advancement of the media 120 through the advance calibration equation. In some examples, the controller is to adjust the position of the media 120 by controlling the displacement mechanism 140 to move the media 120 based on the determined subsequent media advanced distance. In some examples, the controller 150 is to adjust the position of the media 120 by controlling the media input roller and/or the media output roller angular speeds based on the determined media 120 advanced distance. In some other examples, the controller 150 is to adjust the position of the media 120 by controlling the media input roller and/or the media output roller angular positions based on the determined media 120 advanced distance.

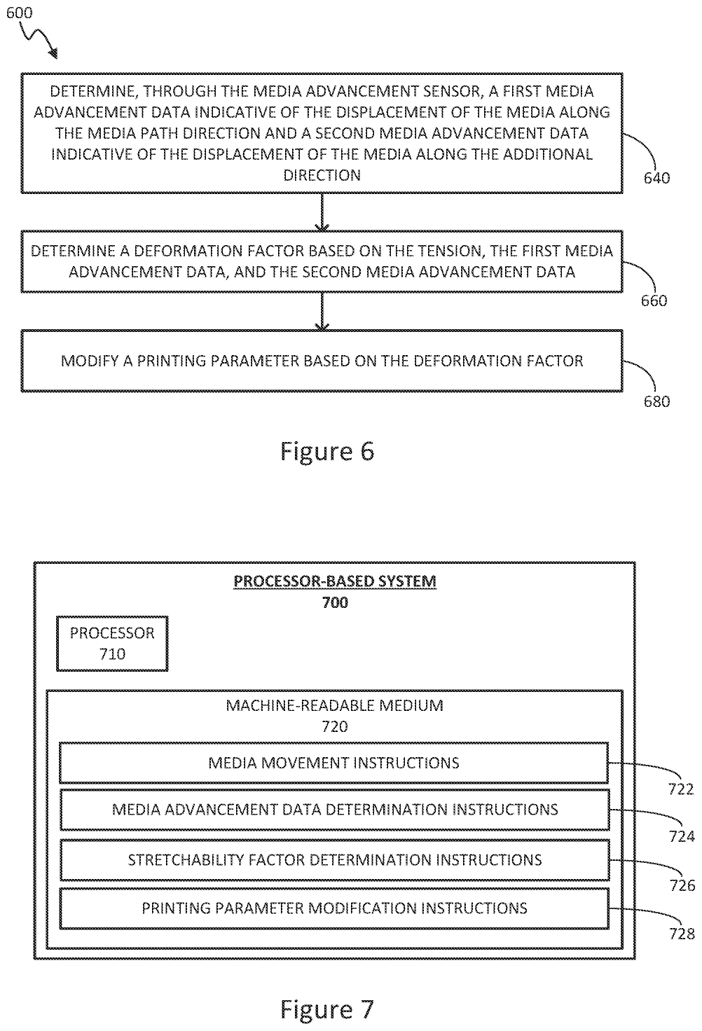

FIG. 6 is a flowchart of another example method 600 for modifying a printing parameter of a printer, such as printer 100. Method 600 may involve previously disclosed elements from FIGS. 1A-B referred to with the same reference numerals. In some examples, parts of the method 600 may be executed by a controller, such as controller 150 from FIGS. 1A-B. Method 600 may be implemented instead of the execution of blocks 240, 260 and 280 from FIG. 2.

Method 600 may be executed on a printing apparatus similar to printer 100, where the media advancement sensor 130 is to measure the displacement of the media with respect to the media path direction 125 and to an additional direction parallel to the platen 110 and substantially orthogonal to the media path direction, for example the carriage scanning direction.

At block 640, the controller 150 is to determine, through the media advancement sensor 130, a first media advancement data indicative of the displacement of the media 120 along the media path direction (see, block 240 of FIG. 2). In addition, at block 640, the controller 150 may further determine, through the media advancement sensor 130, a second media advancement data indicative of the displacement of the media 120 along the additional direction. In some examples, the first and second media advancement data may be determined through the same sensory element. In other examples, the first and second media advancement data may be determined through a different sensory element.

Block 660 may be similar to block 260 of FIG. 2. At block 660, the controller 150 is to determine a deformation factor based on the tension, the first media advancement, and the second media advancement data. As such, the deformation factor determined at block 660 is to further be based on the displacement of the media 120 along the additional direction substantially orthogonal to the media path direction.

Block 680 may be similar to block 280 of FIG. 2. At block 680, the controller 150 is to modify the printing parameter based on the deformation factor.

FIG. 7 is a block diagram showing a processor-based system 700 example to modify a printing parameter based on a stretchability factor. In the examples herein, the instructions of system 500 may involve previously disclosed elements from FIGS. 1A-1B, 2-6 referred to with the same reference numerals.

In some implementations, the system 700 is a processor-based system and may include a processor 710 coupled to a machine-readable medium 720. The processor 710 may include a single-core processor, a multi-core processor, an application-specific integrated circuit (ASIC), a field programmable gate array (FPGA), and/or any other hardware device suitable for retrieval and/or execution of instructions from the machine-readable medium 720 (e.g., instructions 722-728) to perform functions related to various examples. Additionally, or alternatively, the processor 710 may include electronic circuitry for performing the functionality described herein, including the functionality of instructions 722-728. With respect of the executable instructions represented as boxes in FIG. 7, it should be understood that part or all of the executable instructions and/or electronic circuits included within one box may, in alternative implementations, be included in a different box shown in the figures or in a different box not shown.

The machine-readable medium 720 may be any medium suitable for storing executable instructions, such as a random-access memory (RAM), electrically erasable programmable read-only memory (EEPROM), flash memory, hard disk drives, optical disks, and the like. In some example implementations, the machine-readable medium 720 may be a tangible, non-transitory medium, where the term “non-transitory” does not encompass transitory propagating signals. The machine-readable medium 720 may be disposed within the processor-based system 700, as shown in FIG. 7, in which case the executable instructions may be deemed “installed” on the system 700. Alternatively, the machine-readable medium 720 may be a portable (e.g., external) storage medium, for example, that allows system 700 to remotely execute the instructions or download the instructions from the storage medium. In this case, the executable instructions may be part of an “installation package”. As described further herein below, the machine-readable medium may be encoded with a set of executable instructions 722-728.

Instructions 722, when executed by the processor 710, may cause the processor 710 to control a media input roller and/or media output roller to move a media 120 over a platen 110 of a printer 100 at a tension.

Instructions 724, when executed by the processor 710, may cause the processor 710 to determine, through a media advancement sensor 130, media advancement data indicative of the displacement of the media 120.

Instructions 726, when executed by the processor 710, may cause the processor 710 to determine a stretchability factor (e.g., deformation factor) based on the tension and the media advancement data.

Instructions 728, when executed by the processor 710, may cause the processor 710 to modify a printing parameter based on the stretchability factor.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A printing apparatus comprising:
a platen to hold a media thereon, the media moveable along a media path direction;
a displacement mechanism to move the media over the platen and along the media path direction;
a media advancement sensor to measure the displacement of the media;
a controller to:
   control the displacement mechanism to move the media over the platen at a tension;
   determine, through the media advancement sensor, media advancement data indicative of the displacement of the media;
   determine a deformation factor based on the tension and the media advancement data; and
   modify a printing parameter based on the deformation factor.

Feature set 2: A printing apparatus with feature set 1, wherein the controller is to control the displacement mechanism and to determine the media advancement data in an iterative manner, the controller is further to: compare the media advancement data of a plurality of the iterations with an advancement threshold; and determine that the media is a rigid media and that no printing parameter modification is needed if the plurality of media advancement data are lower than the advancement threshold.

Feature set 3: A printing apparatus with any preceding feature set 1 to 2, wherein the controller is to control the displacement mechanism to move the media over the platen at an increasing tension in the different iterations.

Feature set 4: A printing apparatus with any preceding feature set 1 to 3, wherein the controller is further to: compare the deformation factor with an elasticity threshold; determine that the stretchability of the media is out of the specifications if the deformation factor is greater than the elasticity threshold; and modify the printing parameter, if the deformation factor is lower than the elasticity threshold.

Feature set 5: A printing apparatus with any preceding feature set 1 to 4, wherein the displacement mechanism is a media input roller and/or a media output roller.

Feature set 6: A printing apparatus with any preceding feature set 1 to 5, wherein the media advancement sensor comprises a mechanical or an optical sensor.

Feature set 7: A printing apparatus with any preceding feature set 1 to 6, wherein the controller is to modify a printing parameter based on the deformation factor after a media loading and before a print job execution.

Feature set 8: A printing apparatus with any preceding feature set 1 to 7, wherein the printing parameter is a print job image, the controller to modify the print job image based on the deformation factor.

Feature set 9: A printing apparatus with any preceding feature set 1 to 8, wherein the printing parameter is a printhead alignment, the controller to: determine a division of a printhead into different areas; and apply a different correction to at least two of the areas based on the deformation factor.

Feature set 10: A printing apparatus with any preceding feature set 1 to 9, wherein the printing parameter is a printhead alignment, the controller to: determine a division of the printing area on the platen into different zones; and apply, based on the deformation factor, a different correction to the printhead while printing into at least two of the different zones.

Feature set 11: A printing apparatus with any preceding feature set 1 to 10, wherein the printing parameter is the advancement of the media, the controller to: determine a nominal advancement of the media based on the media advancement data and the deformation factor, wherein the nominal advancement of the media is the un-deformed advancement of the media; input the nominal advancement of the media to an advance calibration equation; and determine a subsequent advancement of the media through the advance calibration equation.

Feature set 12: A printing apparatus with any preceding feature set 1 to 11, wherein the media advancement sensor is to measure the displacement of the media with respect to the media path direction and to an additional direction parallel to the platen and substantially orthogonal to the media path direction; the controller further to: determine, through the media advancement sensor, a first media advancement data indicative of the displacement of the media along the media path direction and a second media advancement data indicative of the displacement of the media along the additional direction; determine a deformation factor based on the tension, the first media advancement data, and the second media advancement data; and modify a printing parameter based on the deformation factor.

Feature set 13: A method comprising:
loading a media to a printer;
moving, through a displacement mechanism, the media over along a media path direction of a printer platen at a tension;
measuring, through the media advancement sensor, media advancement data indicative of the displacement of the media;
determining a deformation factor based on the tension and the media advancement data; and
modifying a printing parameter based on the deformation factor.

Feature set 14: A method with feature set 13, further comprising: comparing the deformation factor with an elasticity threshold; determining that the stretchability of the media is out of the specifications, if the deformation factor is greater than the elasticity threshold; and modifying the printing parameter, if the deformation factor is lower than the elasticity threshold.

Feature set 15: A non-transitory machine-readable medium storing instructions executable by a processor, the non-transitory machine-readable medium comprising:
instructions to control a media input roller and/or media output roller to move a media over a platen of a printer at a tension;
instructions to determine, through a media advancement sensor, media advancement data indicative of the displacement of the media;
instructions to determine a stretchability factor based on the tension and the media advancement data; and
instructions to modify a printing parameter based on the stretchability factor.

What it is claimed is:

1. A printing apparatus comprising:
a platen to hold a media thereon, the media moveable along a media path direction;
a displacement mechanism to move the media over the platen and along the media path direction, wherein the media displacement mechanism is to provide a tension to the media;
a media advancement sensor to measure the displacement of the media;
a controller to:
control the displacement mechanism to move the media over the platen at a tension;
determine, through the media advancement sensor, media advancement data indicative of the displacement of the media;
determine a deformation factor based on the tension and the media advancement data; and
modify a printing parameter based on the deformation factor.

2. The printing apparatus of claim 1, wherein the controller is to control the displacement mechanism and to determine the media advancement data in an iterative manner, the controller is further to:
compare the media advancement data of a plurality of the iterations with an advancement threshold; and
determine that the media is a rigid media and that no printing parameter modification is needed if the plurality of media advancement data are lower than the advancement threshold.

3. The printing apparatus of claim 2, wherein the controller is to control the displacement mechanism to move the media over the platen at an increasing tension in the different iterations.

4. The printing apparatus of claim 1, wherein the controller is further to:
compare the deformation factor with an elasticity threshold;
determine that the stretchability of the media is out of the specifications if the deformation factor is greater than the elasticity threshold; and
modify the printing parameter, if the deformation factor is lower than the elasticity threshold.

5. The printing apparatus of claim 1, wherein the displacement mechanism is a media input roller and/or a media output roller.

6. The printing apparatus of claim 1, wherein the media advancement sensor comprises a mechanical or an optical sensor.

7. The printing apparatus of claim 1, wherein the controller is to modify a printing parameter based on the deformation factor after a media loading and before a print job execution.

8. The printing apparatus of claim 1, wherein the printing parameter is a print job image, the controller to modify the print job image based on the deformation factor.

9. The printing apparatus of claim 1, wherein the printing parameter is a printhead alignment, the controller to:
determine a division of a printhead into different areas; and
apply a different correction to at least two of the areas based on the deformation factor.

10. The printing apparatus of claim 1, wherein the printing parameter is a printhead alignment, the controller to:
determine a division of the printing area on the platen into different zones; and
apply, based on the deformation factor, a different correction to the printhead while printing into at least two of the different zones.

11. The printing apparatus of claim 1, wherein the printing parameter is the advancement of the media, the controller to:
determine a nominal advancement of the media based on the media advancement data and the deformation factor, wherein the nominal advancement of the media is the un-deformed advancement of the media;
input the nominal advancement of the media to an advance calibration equation; and
determine a subsequent advancement of the media through the advance calibration equation.

12. The printing apparatus of claim 1, wherein the media advancement sensor is to measure the displacement of the media with respect to the media path direction and to an additional direction parallel to the platen and substantially orthogonal to the media path direction; the controller further to:
determine, through the media advancement sensor, a first media advancement data indicative of the displacement of the media along the media path direction and a second media advancement data indicative of the displacement of the media along the additional direction;
determine a deformation factor based on the tension, the first media advancement data, and the second media advancement data; and
modify a printing parameter based on the deformation factor.

13. A method comprising:
loading a media to a printer;
moving, through a displacement mechanism, the media over along a media path direction of a printer platen at a tension;
measuring, through the media advancement sensor, media advancement data indicative of the displacement of the media;
determining a deformation factor based on the tension and the media advancement data; and
modifying a printing parameter based on the deformation factor.

14. The method of claim 13, further comprising:
comparing the deformation factor with an elasticity threshold;
determining that the stretchability of the media is out of the specifications, if the deformation factor is greater than the elasticity threshold; and
modifying the printing parameter, if the deformation factor is lower than the elasticity threshold;

15. A non-transitory machine-readable medium storing instructions executable by a processor, the non-transitory machine-readable medium comprising:
instructions to control a media input roller and/or media output roller to move a media over a platen of a printer at a tension;
instructions to determine, through a media advancement sensor, media advancement data indicative of the displacement of the media;
instructions to determine a stretchability factor based on the tension and the media advancement data; and
instructions to modify a printing parameter based on the stretchability factor.
